(19) United States
(12) Patent Application Publication
(10) Pub. No.: US 2005/0074546 A1
(43) Pub. Date: Apr. 7, 2005

(54) Micro-dispensing thin film-forming apparatus and method thereof

(76) Inventors: Kevin Cheng, Hsinchu (TW); Chun-Fu Lu, Hsinchu (TW); Wan-wen Chiu, Hsinchu (TW)

Correspondence Address: BIRCH STEWART KOLASCH & BIRCH, PO BOX 747, FALLS CHURCH, VA, 22040-0747, US

(21) Appl. No.: 10/842,535

(22) Filed: May 11, 2004

(30) Foreign Application Priority Data
Oct. 7, 2003 (TW) 92127840

(51) Int. Cl. B05D 5/12

(52) U.S. Cl. 427/58

(57) ABSTRACT

A thin film-forming method and apparatus for forming flat films on a substrate utilizes micro-dispensing inkjet printing. Physical vibration is induced on the substrate to destroy the surface tension of droplets adhering on the substrate. The physical force influence the surface tension and holds the solute in position and prevent them moving by capillary force to the rim of droplet and accumulating there so as to get a flat thin film during the volatilization of the droplet. The vibration also regulates the droplet shape into nearly true round.

### BACKGROUND OF THE INVENTION

1. Field of the Invention

The invention generally relates to a thin film-forming method and apparatus, and in particular relates to a method and apparatus utilizing micro-dispensing inkjet printing and inducing vibration for forming thin films.

2. Related Art

Inkjet printing is a delicate, high-repetitive process being applied in the electronic industry of precise elements. It is applicable to the printings of precise elements of different materials. However, the inkjet printing applied on high-resolution thin film elements requires highly precise positioning for ejecting ink droplets on predetermined positions. Besides, the ink droplets land to the substrate will evaporate before it dry to form a thin film. The uniformity of the thin film is often influenced by the physical condition of evaporation and hard to get ideal film morphology.

There are solid (the substrate), liquid (the ink droplet) and vapor (the volatilized solvent) phases around the ink droplet and the substrate. The surface energy in the solid and liquid interface is less (heat dissipation is faster) than that of in the liquid and vapor. Further, the vapor pressure in the solid and liquid interface is less than that of in the liquid and vapor interface. So, the rim of the ink droplet dries faster than the central portion that makes the center of the film lower than the rim, and a so-called “coffee ring” behavior observed. The uneven film greatly influences the function of the precise element. Therefore, the inhomogeneous film is a major problem of inkjet printing process. The secondary problem is the phase separation during the film drying. The aforesaid problems influence the yield and quality of the element production. Especially, the inkjet printing process is hard to be improved for the high resolution of precise elements.

In order to improve the evenness and quality of film elements, some methods with external force, surface treatment of the substrate and fabrication process modifications has been applied to change or control the volatilization of the ink solvent. For example, in World Patent Publication No. WO01/70506A2, ink droplet on the substrate is dried by air blowing for changing the solvent density gradient of the ink droplet so as to increase the curing speed of the rim of the droplet and to prevent the coffee ring formation. However, the airflow convention influences the position of ink droplet in the air and causes trouble to the droplet positioning. In U.S. Pat. No. 4,510,173, a film organic thin film capable of being cured by energy beams and exhibiting fluidity by heat on the surface of the substrate is applied. It will reflow by applying heat to the organic material and turn into a flattened surface during drying period. Then energy beam irradiated to the flattened organic material to cure the flattened organic material, thereby converting the flattened organic material into a cured film.

Further, in U.S. Pat. No. 6,383,913, a method for improving surface wettability of inorganic low dielectric material is disclosed. The method includes an inorganic dielectric material as a low-k dielectric barrier layer is spun-on the semiconductor device. Then, inorganic dielectric material surface is treated by ultraviolet (UV) treatment that the surface characteristic of inorganic dielectric material is changed from hydrophobic to hydrophilic. Thus, the surface wettability of inorganic dielectric material can be improved and adhesion between the inorganic dielectric material and organic polymer can be increased. Another similar process is disclosed in U.S. Pat. No. 6,162,745. The film forming method includes steps of irradiating an energy beam onto the substrate surface to allow the substrate surface to be modified and forming a filmed area having a high affinity for the solvent and a non-filmed area having a low affinity for the solvent, and forming a solid contents film selectively on the substrate surface.

However, the aforesaid methods still leave the problem of coffee ring to be solved.

By referring to the article “Capillary Flow as the Cause of Ring Stains From Dried Liquid Drops” published on NATURE of 1997, a liquid containing solid solutes generates rings as a natural phenomenon during drying. There are some important aspects in solving the coffee ring problem. In the start of liquid drop drying, solid accumulation at the rim is negligible, therefore, the faster evaporation is the better. Then, the lower liquid viscosity gives the higher flow rate, and generates a thinner and wider film. Further, a larger contact angle means a higher surface tension and a lower evaporation rate. Therefore, destroying the surface tension of the droplet helps formation of flat film.

### SUMMARY OF THE INVENTION

The object of the invention is to provide a film-forming method and apparatus utilizing micro-dispensing inkjet printing. Physical vibration is induced to destroy the surface tension of ink droplets adhering on the substrate. The physical force influence the surface tension and holds the solute in position and prevent them moving by capillary force to the rim of droplet and accumulating there, then get a flat thin film during the drying of the droplet is possible.

A micro-dispensing thin film-forming method for forming a film element on a substrate according to the invention includes the following steps. Inducing vibration of suitable frequency and amplitude to the substrate; dispensing a plurality of droplets on surface of the substrate; and drying the droplets into films formed on the substrate under continuous vibration. The vibration induces the droplet surface with a specific frequency and gives resonance to keep the droplet profile. The frequency is determined by the resonant frequency of the substrate, drop size and the vibration resource structure. The resonance destroys the surface tension of the droplets. The resonance frequency is chosen in a range of 20 Hz to 10 GHz, and a duty ratio of 10% to 90%.

The invention further provides a film-forming apparatus applying aforesaid method for forming film elements on a substrate. The apparatus includes: a micro-dispensing module for dispending a plurality of droplets onto a substrate surface; a carrying pallet for carrying the substrate move relatively to the micro-dispensing module; and a vibration generator for providing continuous resonance to the substrate. Therefore, when the micro-dispensing module dispenses droplets on the substrate, the droplets are vibrated and controlled to form into flat films as the droplets being dried under the resonance. The micro-dispensing module can be any of a bubble inkjet head, piezoelectric inkjet head, arrayer and continuous inkjet device.

Another object of the invention is to improve the peripheral deviation of the droplets during drying into films. Because the vibration influences the shape and surface tension of the droplet, any defect on the substrate or any dispensing condition that harms the peripheral deviation of the droplets is improved by the resonance to the droplet surface.

The vibration amplitude and frequency is controlled to effectively change the evaporation and surface tension of the droplets, and depress the capillary phenomenon to get flat films. The vibration generator can be of some prior arts, such as microwave elements, ultrasonic elements, piezoelectric elements or sound wave devices, for providing vibration to the droplet surface.

### BRIEF DESCRIPTION OF THE DRAWINGS

The invention will become more fully understood from the detailed description given here in below. However, this description is for purposes of illustration only, and thus is not limitative of the invention, wherein:

FIG. 1 is a constructional view of a film-forming apparatus of the invention;

FIG. 2 is a flowchart of a film-forming method of the invention;

FIG. 3 is an application arrangement in a third embodiment of the invention;

FIG. 4 is an amplitude diagram of a planar piezoelectric element applied in the invention;

FIGS. 5A to 5E are amplitude simulation diagrams of different quantities and positions of vibration elements used in the invention;

FIGS. 6A to 6D are amplitude simulation diagrams of different operational frequencies of vibration elements used in the invention;

FIG. 7 is a photo of an apparatus of a first embodiment of the invention;

FIG. 8A is a photo of a deionized water droplet adhering on a substrate before a vibration being induced;

FIG. 8B is a photo of a deionized water droplet adhering on a substrate after a vibration bring induced;

FIG. 9 is a photo of an apparatus of a second embodiment of the invention;

FIGS. 10A to 10C are thickness diagrams of films made by the second embodiment of the invention; and

FIGS. 11A to 11C are thickness diagrams of films made by the third embodiment of the invention.

### DETAILED DESCRIPTION OF THE INVENTION

The invention generates vibration to the substrate and destroys the surface tension of ink droplets adhering on the substrate during evaporation and drying of the droplets so as to get flat films. The quantity, location and control parameters of vibration source influence the drying behavior. The vibration mode varies when the operational frequencies change. The major phenomenon is that lower resonance frequencies under 1 MHz give vibrations parallel with the plane direction of the substrate; and higher frequencies beyond 1 MHz give vibrations perpendicular to the plane direction of the substrate, and destroy the surface tension apparently.

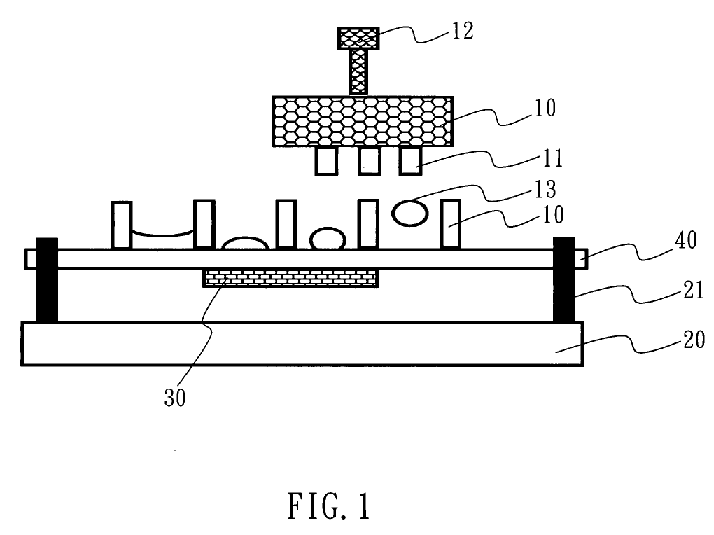

As shown in FIG. 1, a film-forming apparatus according to the invention includes: an inkjet printing module 10 for dispending a plurality of droplets on a substrate 40 surface; a carrying pallet 20 and a supporter 21 for carrying the substrate 40 move relatively to the inkjet printing module 10; and a vibration generator 30 for providing continuous resonance to the substrate 40. The ink jet printing module 10 includes a plurality of nozzles 11 mounted on an adjusting mechanism 12 for dispensing droplets onto the substrate 40. The supporter 21 supports the substrate 40 and keeps a suitable distance to the carrying pallet 20. The vibration generator 30 includes piezoelectric elements mounting under the substrate 40 and free from contact with the carrying pallet 20 so as to prevent energy decay. The vibration generator 30 provides suitable resonance to the droplets 13 dispensed by the nozzles 11 on the substrate 40 and forms flat films as the droplets 13 being volatilized and cured under the resonance.

The high frequency and high voltage operation on PZT will cause the temperature on the PZT surface rising. Table. 1 is a measurement of temperature on different operation conditions. It is notable that for a polymer solution likes PLED, the material will thermal dissociation because of the temperature over material limit, for example, 80° C. But, moderate temperature rising will decrease the viscosity and is helpful to lower the coffee-ring formation. The temperature difference between boundaries of fluid activates Marangoni convection and improves the coffee ring phenomenon

TABLE 1

| | 1 min | 2 min | 3 min | 5 min | 8 min |
|---|---|---|---|---|---|
| 5 V | 30 | 31 | 32 | 32 | 32 |
| 10 V | 45 | 45 | 50 | 50 | 49 |
| 15 V | 92 | 103 | N/A | N/A | N/A |

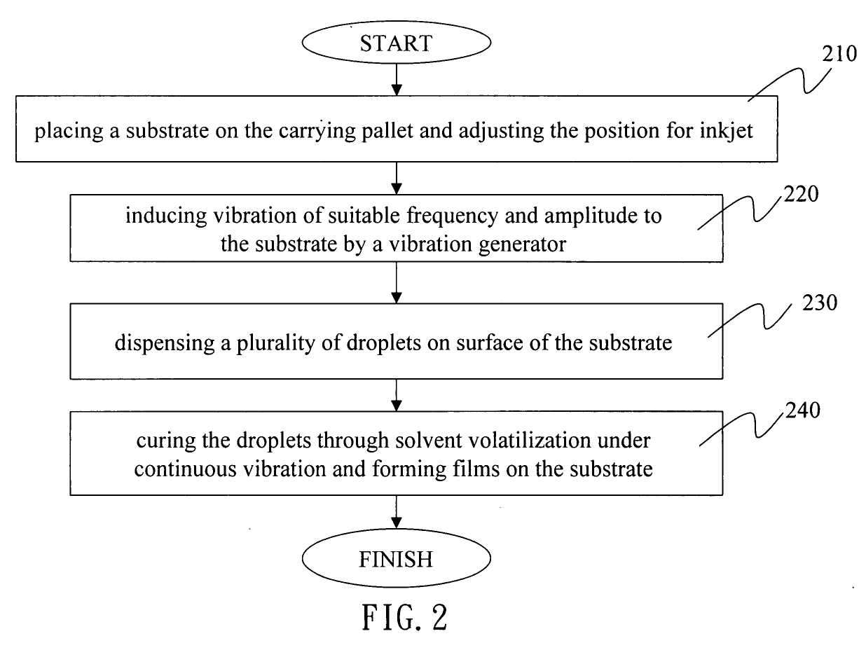

A film-forming method for forming a film element on a substrate according to the invention includes the following steps as shown in FIG. 2. First, placing a substrate on the carrying pallet and adjusting the position for inkjet (step 210). Induce vibration of suitable frequency and amplitude to the substrate by a vibration generator (step 220). Dispense a plurality of droplets on surface of the substrate (step 230). Then, curing the droplets through solvent volatilization under continuous vibration and forming films on the substrate (step 240). The vibration vibrates the droplet surface with a specific frequency and gives resonance to the droplets. The frequency is determined by the resonant frequency of the substrate and the vibration resource structure. The resonance destroys the surface tension of the droplets. An additional temperature control module can be used to control the surface temperature of the substrate.

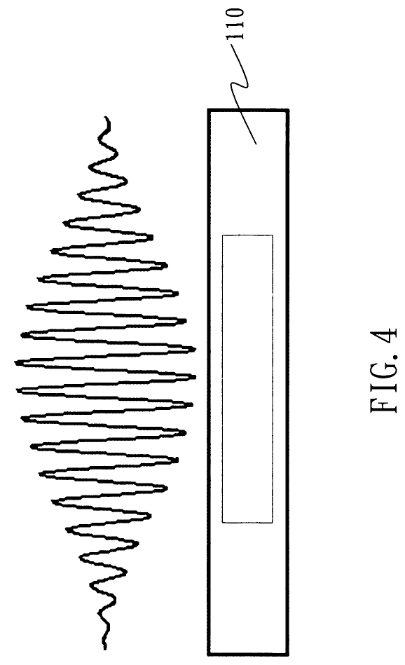

The vibration amplitude of a piezoelectric element decreases outward from the center of the element. FIG. 4 is an amplitude diagram of a planar piezoelectric element applied in the invention. Each PZT element 110 is an independent vibration source that provides higher vibration amplitude at the center and lower vibration amplitudes at the rim. The vibration is determined by parameters of frequency, voltage amplitude, vibration mode (vertical mode, bend mode or harmonic mode), size of the vibrator and size of the droplets. Moreover, the quantity and locations of vibration elements influence the function of the whole vibration generator.

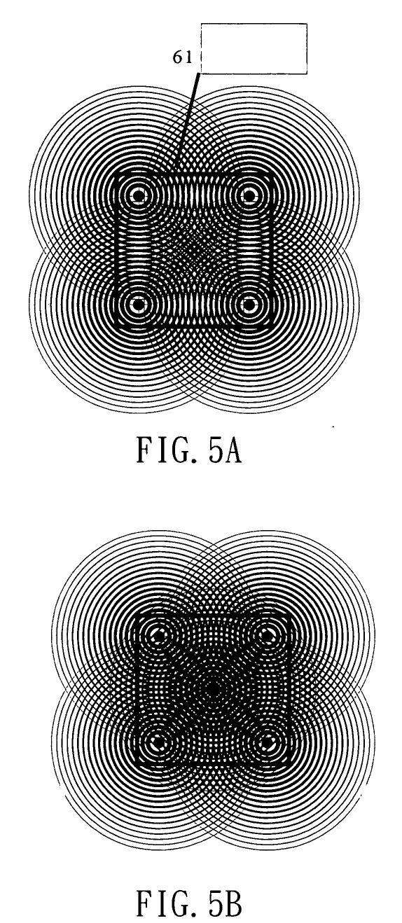

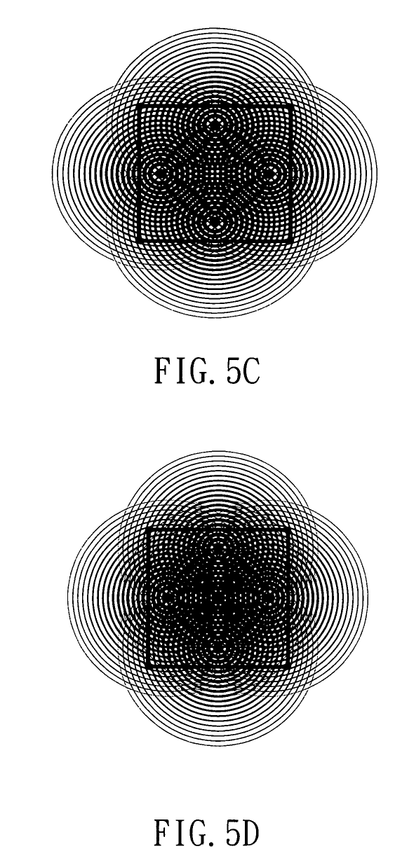

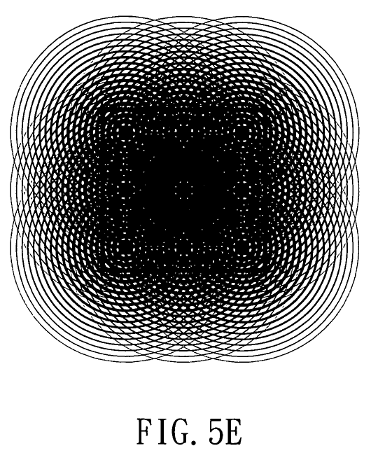

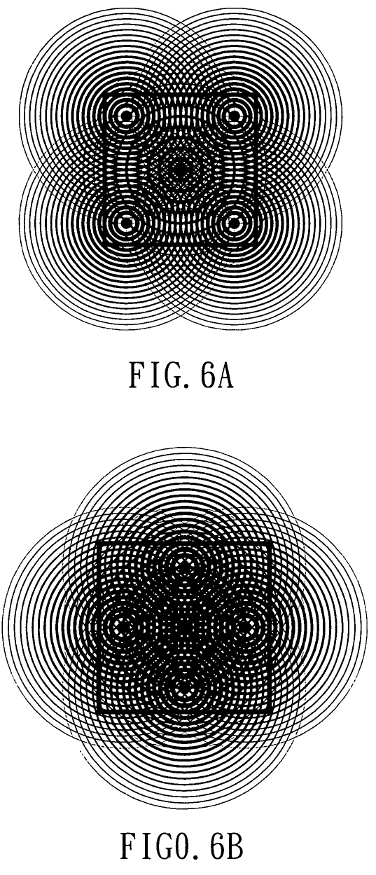

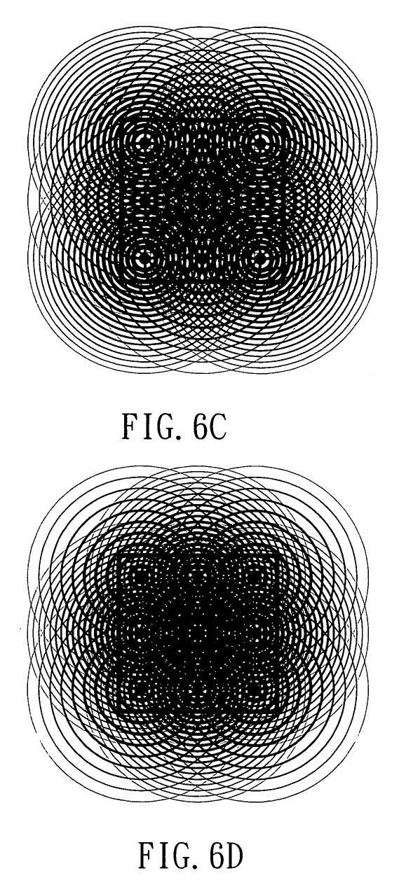

Some examples of amplitude patterns of vibration generators having different quantity, locations and operational frequencies of vibration sources are illustrated in FIGS. 5A to 5E and 6A to 6D. Each vibration element is expressed as a point vibration source. The concentric circles around each center are wave peaks of same phases. Therefore, the portions of condensed circles mean frequent vibrations occurring there. An ideal condition is that circles (i.e., the vibrations) are evenly distributed on the substrate. FIGS. 5A to 5E are amplitude simulation diagrams of different quantities and positions of vibration elements used in the vibration generators. FIG. 5A shows a condition of four vibration elements in four corners of the substrate. FIG. 5B shows a condition of five vibration elements in four corners and at the center of the substrate. FIG. 5C shows a condition of four vibration elements in the middle of four sides of the substrate. FIG. 5D shows a condition of five vibration elements in the middle of four sides and at the center of the substrate. FIG. 5E shows a condition of nine vibration elements in four corners, in the middle of four sides and at the center of the substrate. The vibration elements in the FIGS. 5A to 5E are all with a same amplitude and frequency.

FIGS. 6A to 6D are amplitude simulation diagrams of different operational frequencies of vibration elements used in the vibration generators. FIG. 6A shows a condition of four vibration elements with frequency f in four corners of the substrate, and a vibration element with frequency f/2 at the center. FIG. 6B shows a condition of four vibration elements with frequency f in the middle of four sides of the substrate, and a vibration element with frequency f/2 at the center. FIG. 6C shows a condition of four vibration elements with frequency f in four corners and five vibration elements with frequency f/2 at the center and the middle of four sides of the substrate. FIG. 6D shows a condition of four vibration elements with frequency f in the middle of four sides and five vibration elements with frequency f/2 at the center and four corners of the substrate. The aforesaid conditions of FIGS. 5A to 5E and 6A to 6D show us that the quantities, locations and operational frequencies all influence the film-forming effects. The more even vibration amplitude provides the more flat droplet and film. Therefore, the arrangements of the vibration elements are preferably in symmetric locations.

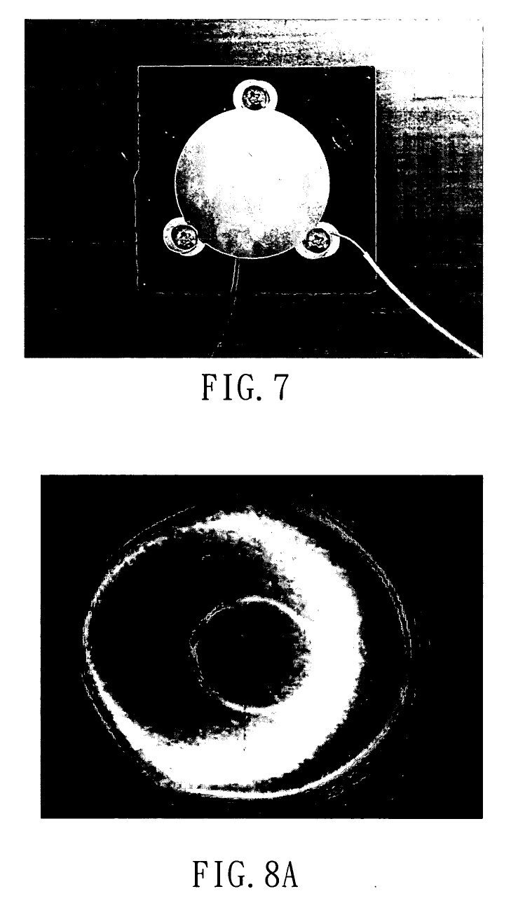

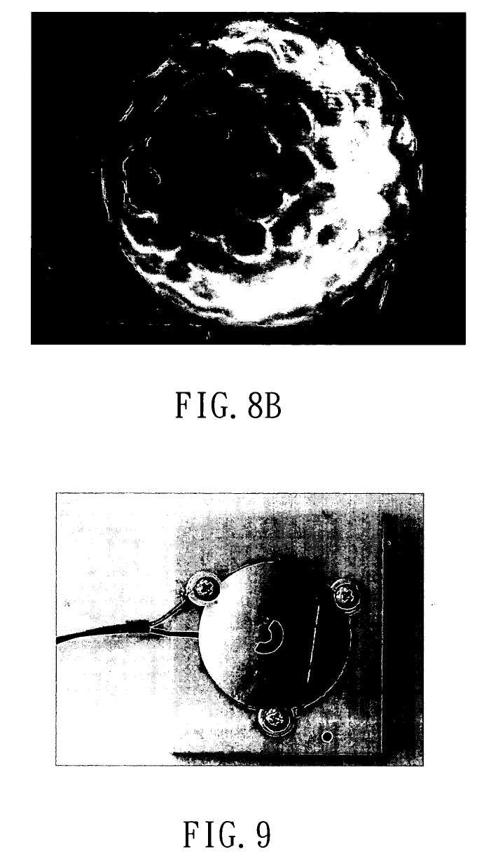

To prove the effectiveness of the invention, a solution of deionized water with Phoenolic, PF (which is used for making films of PLED) is used as inkjet fluid and applied in an application apparatus as shown in the photo of FIG. 7. The vibration element is a PZT buzzer (model No. OBO-41208-16). A Deckglaser cover glass with dimensions of 22*22 mm and 0.175 mm thickness is used as a substrate. An HP 51626 inkjet head is used to provide droplets with diameters of 100 to 200 microns. The vibration element is fixed on three points to the substrate. The input for the vibration element is 12,4V, 1.922 Khz and 50% duty ratio. The solution dispensed by the inkjet head onto the substrate is observed and set with a diameter of 5000 microns. As shown in the photo of FIG. 8A, before the vibration being applied, the shape of the droplet is not true round. Then, in the photo of FIG. 8B, vibration is applied on the droplet to provide standing waves destroying the surface tension, the droplet is formed with nearly true roundness.

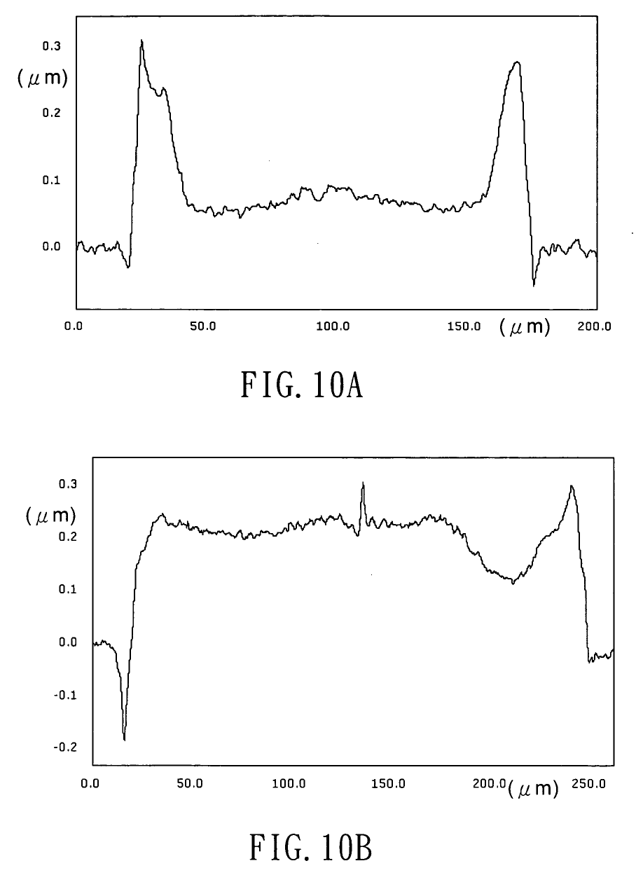

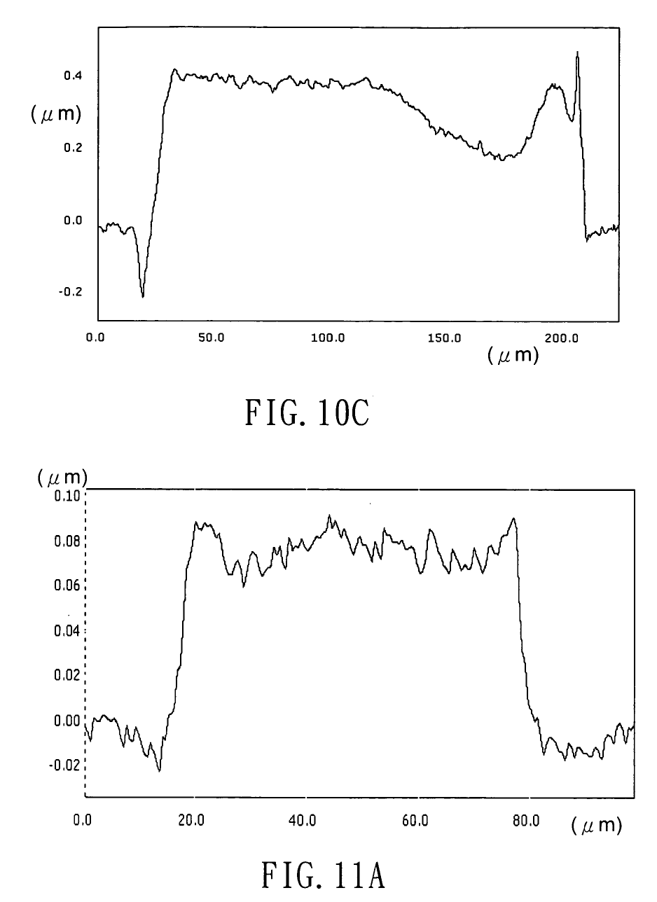

A second application apparatus using solution of Phoenolic, PF in deionized water to form a film is shown in the photo of FIG. 9. The vibration element is a PZT buzzer (model No. OBO-41208-16). A Deckglaser cover glass with dimensions of 22*22 mm and 0.175 mm thickness is used as a substrate. An HP 51626 inkjet head is used to provide droplets with diameters of 100 to 200 microns. The vibration element is fixed on three points to the substrate. The input for the vibration element is set to 12,4V and with 100 kHz, 200 kHz and 500 kHz respectively, while remains a 50% duty ratio. The solution dispensed by the inkjet head onto the substrate is dried (in about 2 or 3 seconds) and measured of its sectional thickness, as shown in FIGS. 10A to 10C. In FIG. 10A, the frequency for the vibration element is 100 kHz. In FIG. 10B, the frequency is 200 kHz. In FIG. 10C, the frequency is 500 kHz. They show that increasing the vibration frequency helps the fluid move to the center. The film formed under 500 kHz frequency has uniform thickness along the center and the rim and is free from the coffee ring structure. Therefore, a higher frequency vibration gives a better result.

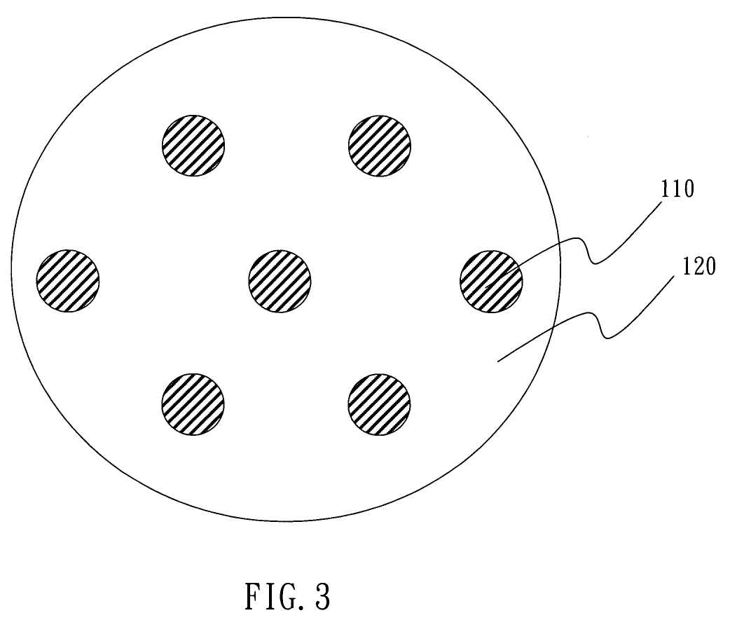

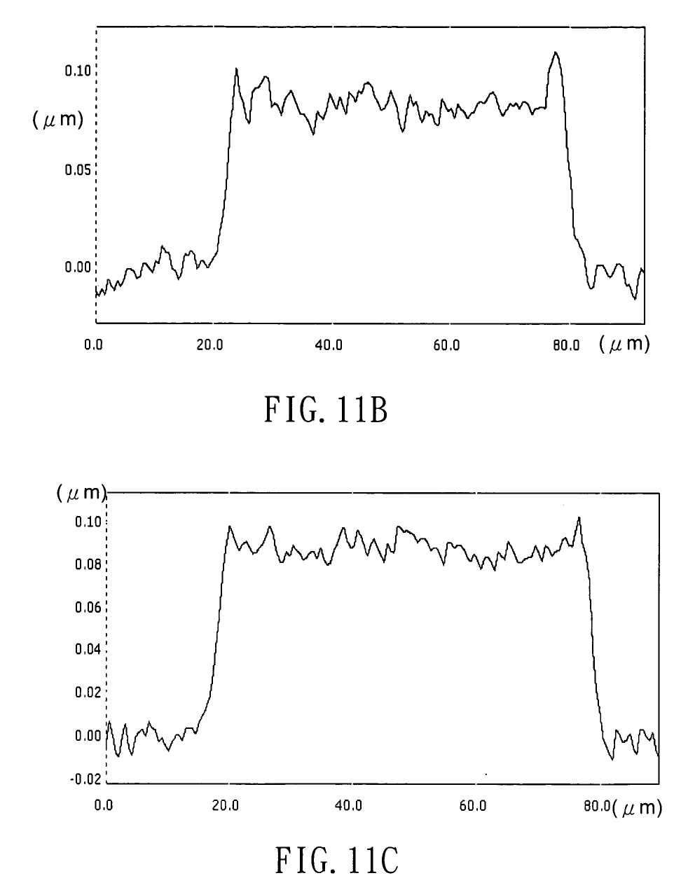

A third application apparatus using solution of Phoenolic, PF in deionized water to form a film is shown in FIG. 3. Seven PZT vibration elements are symmetrically mounted under a carrying pallet 120. A glass with dimensions of 70*70 mm and 0.7 mm thickness is used as a substrate. An inkjet head provides droplets with diameters of 100 to 200 microns. The input for the vibration element is set to 80V and with 100 kHz, 300 kHz and 400 kHz respectively, while remains a 50% duty ratio. The solution dispensed by the inkjet head onto the substrate is dried (in about 2 or 3 seconds) and measured of its sectional thickness, as shown in FIGS. 11A to 11C. In FIG. 11A, the frequency for the vibration element is 100 kHz. In FIG. 11B, the frequency is 300 kHz. In FIG. 11C, the frequency is 400 kHz. They show that a plurality of PZT vibration elements give better flatness of the films than that of the aforesaid second application. Therefore, more vibration elements improve the effect.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A micro-dispensing thin film-forming method for forming a thin film element on a substrate, comprising the steps of:
inducing a vibration to the substrate continuously;
dispensing a plurality of droplets on surface of the substrate; and
drying the droplets through solvent evaporation under the vibration and forming thin films on the substrate free from solute accumulation on rim of the droplet by functions of the vibration that destroys surface tension of the droplet.

2. The micro-dispensing thin film-forming method according to claim 1 wherein the vibration frequency is in a range of 20 Hz to 10 GHz.

3. The micro-dispensing thin film-forming method according to claim 1 wherein the vibration has a duty ratio of 10% to 90%.

4. The micro-dispensing thin film-forming method according to claim 1 wherein amplitude of the vibration is parallel to plane direction of the substrate.

5. The micro-dispensing thin film-forming method according to claim 1 wherein amplitude of the vibration is perpendicular to plane direction of the substrate.

6. A micro-dispensing thin film-forming apparatus for forming a thin film element on a substrate, comprising:
a dispensing module, for dispensing a plurality of droplets onto surface of the substrate;
a carrying pallet, for carrying the substrate relatively movable to the dispensing module; and
a vibration generator, having a plurality of vibration elements, for inducing a vibration continuously to the substrate to destroy surface tension of the droplet during curing through solvent volatilization and forming films on the substrate free from solute accumulation on rim of the droplet by functions of the vibration.

7. The micro-dispensing thin film-forming apparatus according to claim 6 wherein the dispensing module is selected from a group consisted of bubble inkjet head, piezoelectric inkjet head, arrayer and continuous inkjet device.

8. The micro-dispensing thin film-forming apparatus according to claim 6 wherein the vibration element is selected from a group consisted of microwave element, ultrasonic element, piezoelectric element and sound wave device.

9. The micro-dispensing thin film-forming apparatus according to claim 6 wherein the vibration element is a lead zirconium-titanate piezoelectric element.

10. The micro-dispensing thin film-forming apparatus according to claim 6 wherein the vibration element is attached to the substrate.

11. The micro-dispensing thin film-forming apparatus according to claim 6 wherein the vibration generator comprises a plurality of vibration elements mounted symmetrically on the substrate.

12. The micro-dispensing thin film-forming apparatus according to claim 11 wherein the vibration elements are operated with different amplitudes and frequencies.

13. The micro-dispensing thin film-forming apparatus according to claim 6 further comprises a temperature controller for controlling surface temperature of the substrate.
